(19) United States
(12) Patent Application Publication
(10) Pub. No.: US 2009/0050225 A1
(43) Pub. Date: Feb. 26, 2009

(54) System for Piping Under Roadways

(76) Inventor: Dave Thomas, Auburn, AL (US)

Correspondence Address: BRADLEY ARANT ROSE & WHITE, LLP;INTELLECTUAL PROPERTY DEPARTMENT-NWJ, 1819 FIFTH AVENUE NORTH, BIRMINGHAM, AL, 35203-2104, US

(21) Appl. No.: 12/087,445

(22) PCT Filed: Jan. 6, 2006
(86) PCT No.: PCT/US2006/000464

§ 371 Date: Jul. 7, 2008

(51) Int. Cl. F16L 9/18; F16L 57/00; G01M 3/08

(52) U.S. Cl. 138/104; 138/111; 405/157; 73/46; 138/105; 138/90

(57) ABSTRACT

What is disclosed is an improved system for gas piping under roadways using polyethylene pipe (2) as a casing pipe around an inner carrier pipe (1), along with a method for testing airtightness. A conduit (10) for the tracer wire (9) is included, along with an accompanying procedure for bypassing the flow of gas through the tracer wire conduit.

### FIELD OF THE INVENTION

The present invention is a novel system for improvements to piping for gas transmission under roadways.

### BACKGROUND OF THE INVENTION

It is well known in the art to surround a carrier pipe transmitting gas under roadways with an outer casing pipe. The current art is for the casing pipe to be made of steel, as transportation department regulations among the many states generally require steel casings. Steel pipe, however, is much more expensive than polyethylene pipe (also “PE” pipe), and so it would be desirable to devise a means for installing PE casing pipe if it meets regulatory requirements.

It has also been known in the art to supply a tracer wire along a non-metallic piping installation to allow location of underground lines by means of surface instruments. Supplying a conduit of pipe for the tracer wire under a roadway would provide protection for the tracer wire underneath the roadway, and also allow a bypass for transmission of the gas in the carrier pipe in the event the latter was damaged and flow was interrupted.

It has also been known in the art to test the airtightness of piping systems with air pressure, but this has not been done with casing pipes under roadways. It would be beneficial to test the casing pipe in such a manner.

It is also well known in the art to provide one or more vent pipes for casing pipes to allow any gas leaking from the carrier pipe to escape to the atmosphere and reduce the risk of fire or explosion. These vent pipes have typically been made of steel or other metal, but such rigid materials are not necessary and can cause hazards above ground from collisions with people or vehicles. It would be desirable to provide a safer material and means of construction to reduce any hazard from such above-ground impacts.

### BRIEF DESCRIPTION OF THE FIGURES

FIG. 1 is a side view of the outer casing pipe which surrounds the inner carrier pipe, and its relationship to the inner carrier pipe, the casing spacer, and the casing end seals, and the polyethylene tracer wire conduit and tracer wire.

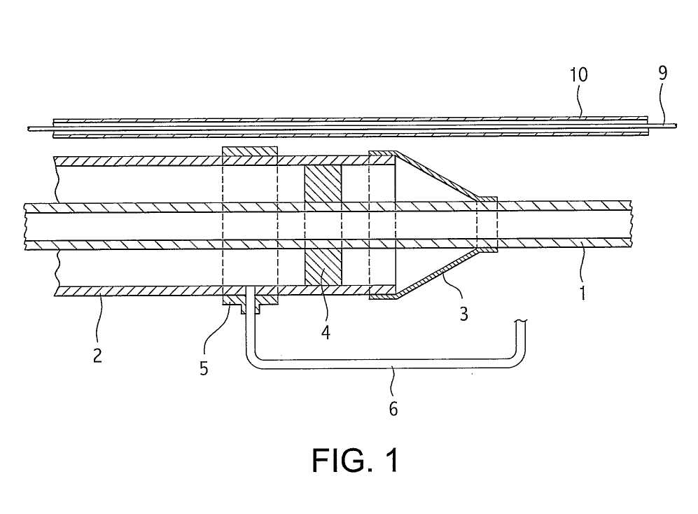

FIG. 2 is a side view of the improved system for piping under roadways.

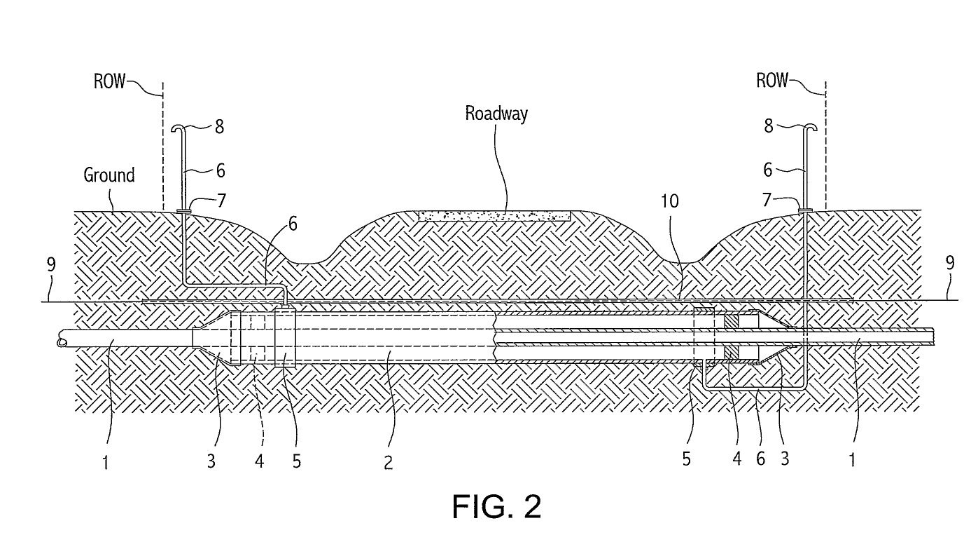

FIG. 3 shows the configuration for the outer casing pipe testing procedure including the supply of compressed air.

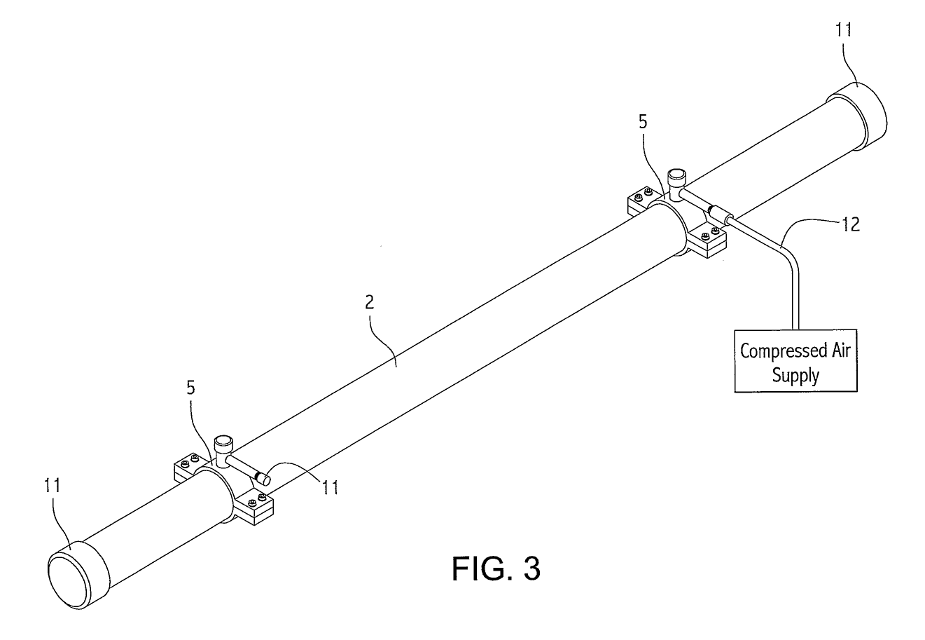

FIG. 4 shows the bypass configuration during the testing phase. The vent pipes are omitted.

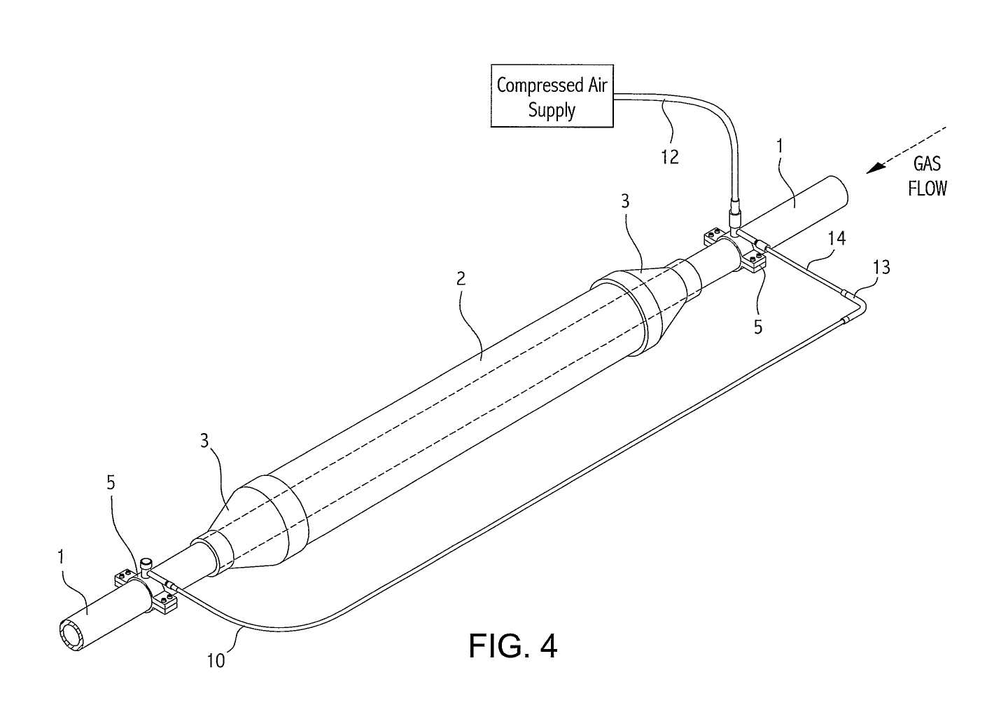

FIG. 5 shows the bypass configuration fully assembled and after the testing phase with the gas supply shut off in the carrier pipe, and the gas flowing through the bypass.

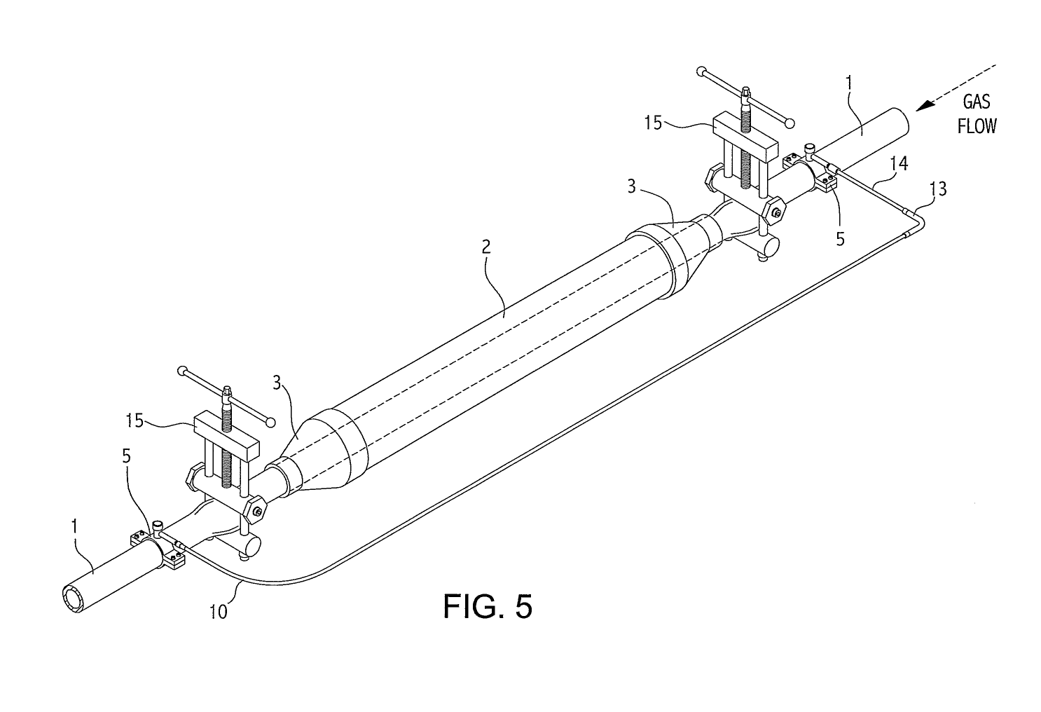

### DETAILED DESCRIPTION

The process of extending gas piping underneath roadways is the subject of state and municipal codes and regulations. See, e.g., Alabama DOT Standard Specifications for Highway Construction, 2002 Edition (hereinafter “ALDOT Specifications.”) As defined herein, the terms “roadway” or “road” include other structures including, without limitation, railroad tracks. The invention disclosed herein is for installation underneath new or existing roads. Unless certain other precautions are taken, these gas piping systems under roadways must contain a carrier pipe 1 which actually contains the gas, and an outer casing pipe 2 which is intended to protect the inner carrier pipe so as to prevent rupture or, in the event of rupture, capture the gas in the carrier pipe. The smaller carrier pipe 1 runs within the larger casing pipe 2 and the carrier pipe 1 is stabilized within the casing pipe 2 by at least two casing spacers 4. An example of suitable casing spacers is the kind manufactured by Corrosion Control Products of Gardena, Calif. The interior space created by the casing pipe around the smaller carrier pipe is enclosed at the ends of the casing by casing end seals 3, an example of which is also manufactured by Corrosion Control Products.

Because of the movement of the underlying road bed over time, the carrier pipe has been specified by codes and regulations as being made of steel. See, e.g., Alabama Specifications at § 862, at pages 8-94 to -95. The pipe cited in this section is steel pipe, as in ASTM A 53, Sch. 40, ASTM A 139, Grade B, and in ASTM A 283, Grade B. It is believed, however, that polyethylene pipe (also “PE pipe”) will gain acceptance in the future as being suitable for casings by state and municipal rulemaking authorities, as PE is strong, corrosion-free and less costly than steel pipe. PE pipe has been in use since the mid 1900s and has a well developed performance record.

Accordingly, disclosed herein is a casing pipe made of PE pipe instead of steel. PE pipe has been improved over the years so that the current types are all acceptable for use in the disclosed invention, and these types include, without limitation, medium density polyethylene (also “MDPE”), high density polyethylene (also “HDPE”) and polyethylene 100 (also “PE 100”). The PE casing pipe disclosed is broad enough to include any kind of PE pipe.

The PE casing pipe is incorporated into a system of protection under the road way which also includes casing spacers 4, casing end seals 3, saddle tees 5, and vent pipes 6. Saddle tees (or tapping tees) are t-shaped and connect pieces of pipe heading in different directions, and have a cutter which is threaded into the main, creating an opening into the carrier pipe, (also referred to as “the main”). Saddle tees can be bolt-on or heat fusion (also “electrofusion”). Unless otherwise specified, all connections in the system should be airtight. For polyethylene pipe, this is accomplished by heat fuse welding (also known as the process of heat fusion) or by use of other components which are bolted on, called bolt-on. Fusion tees are used in the preferred embodiment, as they form an airtight and permanent bond between two lengths of pipe. Bolt-on tees are also rated to be air tight and can be installed without using expensive heat fusion equipment. Normal heat fusion saddle tees and bolt-on saddle tees have an internal tapping shell cutter with a ⅜″ or ⅝ opening. High volume tees allow more gas flow from the tees used to make the connection, having an internal tapping shell cutter up to 2″ for greater volumes of gas flow, and are recommended as the preferred embodiment in the bypass operations described below. Examples of these products are PermaLock™ mechanical tapping tees available from Perfection Corporation of Madison, Ohio.

The PE casing pipe is buried preferably at least six feet below the roadway to allay regulating agencies' possible concerns about the relative strength of a PE casing pipe versus steel. It is feasible, however, to install a PE casing pipe less than six feet below the roadway, i.e., at the same depth four foot as steel pipe, and it is believed that regulating agencies will adopt this view with the passage of time. The current code requires steel casings to be at least four feet beneath the roadway, and PE casings can also be installed safely at four feet. Engineering Manual of Performance Pipe, Chevron Phillips Chemical (2003 1st Ed.) at Book 2, Chapter 7, pages 81-114. The ends of the casing pipe should reach to within five feet of the roadway right-of-way for an installation running parallel to the roadway. For a cross-country installation, the casing pipe ends should reach to the edge of the roadway right-of-way.

When the carrier pipe is within the outer PE casing pipe, it is described as “inner carrier pipe.” When the reference is to the portion of carrier pipe outside the casing end seals, the term “inner” is omitted.”

The tracer wire 9 is typically a vinyl insulated copper wire (e.g., 12 gauge) which runs the length of the entire installation of polyethylene carrier pipe and allows surface instruments to locate underground piping. The tracer wire is thus parallel to and in close proximity to the carrier pipe and the casing pipe as they run under the road bed, and the tracer wire runs outside the ends of its conduit 10. The polyethylene tracer wire conduit 10 can be open at both ends or, preferably, can be sealed with a barrier to prevent dirt or water from filling the polyethylene tracer wire conduit including, without limitation, duct tape or silicone sealant. Any such barrier at the ends of the polyethylene tracer wire conduit must allow the tracer wire to remain intact. The barrier at the ends of the conduit need not be airtight as water or soil will not interfere with its service as a tracer, and after it is unearthed for use as a bypass sufficient water or soil can be removed from the conduit by pushing compressed air through it.

A tracer wire conduit 10—preferably of PE—is disclosed herein which protects the integrity of the tracer wire under the road, and also shields the casing pipe from any electrical current which can be introduced to the tracer wire by means of accidental connections to electrical supply or lightning strikes. It also does double duty as a length of pipe for bypassing the carrier pipe if it is out of service. For installing the bypass, first, the tracer wire should be cut and removed from its conduit. Each of two saddle tees 5 is connected directly to the carrier pipe (outside of the casing end seals on the casing pipe). Then each saddle tee on the carrier pipe is connected to each end of the polyethylene tracer wire conduit by bending the end of the polyethylene tracer wire conduit. In another embodiment a 90 degree ell 13 is added to each end of the polyethylene tracer wire conduit and each ell is connected directly to each saddle tee on the carrier pipe. In another embodiment one end of the polyethylene tracer wire conduit can be bent, and at the other end of the polyethylene tracer wire conduit the 90 degree ell is added. An additional length of pipe 14 can be added to bridge the distance between the 90 degree ell 13 or the end of the polyethylene tracer wire conduit. The polyethylene tracer wire conduit is then tested by removing the cap on one of the saddle tees on the carrier pipe, and then supplying compressed air of at least 100 PSIG and monitoring it for one hour to insure the air pressure does not fall below 100 PSIG. If the test on the polyethylene tracer wire conduit is successful then the cutter in the saddle tees is then used to open the connection to the carrier pipe. The gas then flows through the polyethylene tracer wire conduit as a bypass and subsequently the flow of gas is stopped by means of a squeeze off tool 15 at two locations on either side of the casing pipe: between each saddle tee and each casing end seal. Thus, the flow of gas is not interrupted to downstream customers and repair operations for the carrier pipe under the roadway can commence.

The PE pipe (either in the casing or the tracer wire conduit) can be heat-fused together using the applicable Department of Transportation regulations in practice at the time of installation. For diameters 8″ or less, no heat fusion is required because this PE pipe can be provided in rolls of approximately 500 feet. Any heat fusion welds should be inspected and approved by a Qualified Polyethylene Fusion operator. For testing the carrier, pipe end caps 11 should be heat-fused onto the casing using the applicable Department of Transportation regulations in practice at the time of installation. The heat fusion welds should be inspected and approved by a Qualified Polyethylene Fusion operator.

The casing pipe 2 should be installed under the roadway or other desired location using the installation method approved by the casing owner. This may include, but not limited to, directional drilling, dry boring, or open trenching. Saddle tees 5 should preferably be heat-fused installed on the casing using the applicable Department of Transportation regulations in practice at the time of installation. The heat fusion welds should be inspected and approved by a Qualified Polyethylene Fusion operator. Bolt-on saddle tees are acceptable and can be substituted if approved by the casing owner.

For the testing of air tightness of the PE casing pipe, after connecting both saddle tees 5 to the PE casing pipe 2 the taps on the saddle tees 5 should be visibly checked to ensure full open taps. One saddle tee 5 should be capped for the test and the other tap is hooked to a compressed air supply 12 for the test. The casing pipe 2 will be preferably tested with air for 1 hour at 100 PSIG minimum and this test should be documented by use of a recording gauge with a test chart. This chart should be reviewed by the installer and approved for use at the completion of the test. If the test chart is approved for use, the installation may proceed. The test medium air will be removed from the casing by bleeding off the line pressure through the test saddle tee. The caps 11, on the ends of the PE casing pipe 2 and also on the ends of the saddle tees 5, are used for testing but will be removed afterward. The installation will proceed with installation of the vent pipe 6 and the inner carrier pipe 1.

There are preferably two vent pipes 6, one on each side of the roadway, which extend approximately two feet above the surface. These are connected to the PE casing pipe 2 to allow any leaking gas to escape to the atmosphere and reduce the risk of fire or explosion in the case of flammable gases such as natural gas. One vent pipe should be connected to the uppermost side of the casing pipe, and the other connected to the bottom side. The connection is preferably a saddle tee—either fusion or bolt-on—and high volume is recommended. The vent pipe is field located as required but above ground is preferably within five feet of the right-of-way line. The vent pipe can be composed of any sturdy material, but in a preferred embodiment the material is rigid polyvinylchloride (PVC) as the vent pipe is not intended to contain gas under pressure, but is for reducing any build up of pressure in the casing pipe. A vent pipe is preferably connected to the casing pipe within three feet of each end of the casing pipe. A breakaway flange 7 can be installed at or near ground level to enhance the safety of the above ground portion of the vent pipe. The ell 8 at the top of the vent pipe is 180 degrees, either in one piece or in two 90 degree ells connected to one another, so that the vent is open to the atmosphere but precipitation does not enter the vent pipe. The top of the vent pipe may also be capped with a non-airtight cap.

I claim:

1. An outer polyethylene casing pipe for enclosing an inner carrier pipe for gas transmission underneath a roadway.

2. The outer polyethylene casing pipe as in claim 1 in which the pipe is constructed from a group consisting of polyethylene, medium density polyethylene, high density polyethylene or polyethylene 100.

3. A polyethylene tracer wire conduit for surrounding a tracer wire, said tracer wire and said polyethylene tracer wire conduit being outside of, parallel to and in close proximity with the outer polyethylene casing pipe.

4. At least one vent pipe constructed of polyvinylchloride connected to the outer polyethylene casing pipe and having a breakaway flange at ground level.

6. A system for gas piping under a roadway, comprising:
the outer polyethylene casing pipe surrounding the inner carrier pipe, said outer polyethylene casing pipe being sealed at the ends by means of a casing end seal and also having at least one saddle tee connecting to a vent pipe;
the inner carrier pipe, being surrounded within the outer polyethylene casing pipe and the casing end seals, and being supported therein by at least one casing spacer, said inner carrier pipe being connected at both ends to a larger transmission system;
at least one casing spacer encircling the inner carrier pipe and contacting the inner wall of the outer polyethylene casing pipe;
at least one casing end seal enclosing the interior space created by the outer polyethylene casing pipe around the inner carrier pipe;
the at least one vent pipe, connected to the outer polyethylene casing pipe by means of at least one saddle tee;
the at least one saddle tee connecting the outer polyethylene casing pipe to the at least one vent pipe; and
a tracer wire outside of, parallel to, and in close proximity with the outer polyethylene casing pipe.

6. The system as in claim 5, with the addition of the polyethylene tracer wire conduit surrounding the tracer wire.

7. The system as in claim 5, wherein the vent pipe is composed of polyvinylchloride and has a breakaway flange at ground level.

8. A method for testing air-tightness of the outer polyethylene casing pipe before the said the inner carrier pipe is made operational, comprising:
Installing a pipe end cap on both ends of the outer polyethylene casing pipe;
Installing a pipe end cap on one of the saddle tees;
Removing the cap on another of the saddle tees;
Supplying at least 100 PSIG air pressure to the saddle tee whose cap has been removed;
Monitoring the air pressure to insure it remains at least 100 PSIG;
Removing the compressed air supply from the saddle tee; and
Reducing the excess air pressure through the saddle tee whose cap has been removed.

9. A method for by-passing gas transmission in the inner carrier pipe by transferring transmission through the polyethylene tracer wire conduit, comprising:
Removing the tracer wire from the polyethylene tracer wire conduit;
Attaching a saddle tee to the outer polyethylene carrier pipe at each of the approximate locations corresponding to the ends of the polyethylene tracer wire conduit;
Bending each end of the polyethylene tracer wire conduit towards each of the saddle tees on the carrier pipe;
Connecting each end of the polyethylene tracer wire conduit to each saddle tee on the carrier pipe;
Removing the cap on one of the saddle tees on the carrier pipe;
Supplying at least 100 PSIG to the one saddle connection tee whose cap has been removed;
Monitoring the air pressure in the polyethylene tracer wire conduit to insure it remains at least 100 PSIG;
Removing the compressed air pressure from the one saddle tee whose cap has been removed;
Reducing the excess air pressure through the one saddle tee whose cap has been removed;
Cutting an opening to the carrier pipe on each of the saddle tees;
Allowing flow of gas through the polyethylene tracer wire conduit; and
Stopping the flow of gas through the inner carrier pipe by squeezing the carrier pipe at the two locations between each saddle tee and each casing end seal.

10. The method in claim 9, in which the end of the polyethylene tracer wire conduit is not bent but is connected to a 90 degree ell which is connected to a piece of polyethylene pipe which is connected on the other end to each saddle tee on the carrier pipe.
